(19) United States
(12) Patent Application Publication
(10) Pub. No.: US 2004/0062034 A1
(43) Pub. Date: Apr. 1, 2004

(54) Direct backlight module

(75) Inventors: Chin-Kun Hsieh, Hsinchu (TW); Chuan-Pei Yu, Ilan (TW); Han-Chou Liu, Hsinchu (TW)

Correspondence Address: Richard P. Berg, Esq., c/o LADAS & PARRY, Suite 2100, 5670 Wilshire Boulevard, Los Angeles, CA, 90036-5679, US

(73) Assignee: AU Optronics Corp.

(21) Appl. No.: 10/613,490

(22) Filed: Jul. 2, 2003

(30) Foreign Application Priority Data
Jul. 19, 2002 (TW) 91116113

(51) Int. Cl. G09F 13/04

(52) U.S. Cl. 362/97

(57) ABSTRACT

A direct backlight module. The direct backlight module includes a diffuser, a prism, a diffusing plate, a reflecting plate and an illumination tube. The prism is disposed on the diffuser. The diffusing plate is disposed on the diffuser. The reflecting plate is disposed under the diffuser and has a first reflecting portion, a second reflecting portion and a third reflecting portion. The first reflecting portion is adjacent to the second reflecting portion and the second reflecting portion is adjacent to the third reflecting portion. The illumination tube is disposed between the diffuser and the reflecting plate and located above the first reflecting portion. The light beams from the illumination tube enter the diffuser directly and via reflections among the first reflecting portion, the second reflecting portion and the third reflecting portion.

### BACKGROUND OF THE INVENTION

1. Field of the Invention

The present invention relates to a direct backlight module, and in particular to a direct backlight module reducing reflection of ineffective light beams back to the illumination tube.

2. Description of the Related Art

Referring to FIG. 1, because the reflecting plate 11 of the conventional direct backlight module 1 is a planar surface, some of the light beams from the illumination tube 12 are reflected back to the illumination tube 12 by the reflecting plate 11. Nevertheless, the light beams reflected back to the illumination tube 12 are almost ineffective, thus reducing optical utility of the illumination tube 12.

FIG. 2A shows another conventional direct backlight module 2 to enhance optical utility of the illumination tube. Because of the structure of the reflecting plate 27 of the conventional direct backlight module 2, the ineffective light beams reflected back to the illumination tube 24 by the reflecting plate 27 are enormously reduced. As shown in FIG. 2B, the reflecting plate 27 is composed of multiple reflecting portions. Namely, the reflecting plate 27 is composed of multiple minor curved surfaces 27a, 27b, 27c, 27d, 27e, 27f and 27g. Thus, most of the light beams reflected by the reflecting plate 27 enter the diffuser 25, enhancing optical utility of the illumination tube 24.

However, the conventional direct backlight module 2 has the following drawbacks. Because the reflecting plate 27 is composed of multiple minor curved surfaces 27a-27g, it is very difficult to form the reflecting plate 27 in the molding process. Manufacture and formation of the mold for the reflecting plate 27 is not easy, and the precision of the reflecting plate 27 is not easily controlled. Thus, the manufacturing cost of the reflecting plate 27 is tremendously increased.

Consequently, the invention provides a simplified direct backlight module to reduce ineffective light beams reflecting back to the illumination tube. In addition, the thickness of the direct backlight module is reduced while illumination of the direct backlight module is enhanced.

### SUMMARY OF THE INVENTION

An object of the invention is to provide a direct backlight module. The direct backlight module comprises a diffuser; a reflecting plate disposed under the diffuser and having a first reflecting portion, a second reflecting portion and a third reflecting portion, wherein the first reflecting portion is adjacent to the second reflecting portion and the second reflecting portion is adjacent to the third reflecting portion; and an illumination tube disposed between the diffuser and the reflecting plate and located above the first reflecting portion, wherein the light beams from the illumination tube enter the diffuser directly and via reflections among the first reflecting portion, the second reflecting portion and the third reflecting portion.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a schematic view showing a conventional direct backlight module;

FIG. 2A is a schematic view showing another conventional direct backlight module;

FIG. 2B is a schematic view showing the structure of the reflecting plate according to FIG. 2A;

FIG. 3 is a schematic view showing the first embodiment of the direct backlight module of the invention; and

FIG. 4 is a schematic view showing the second embodiment of the direct backlight module of the invention.

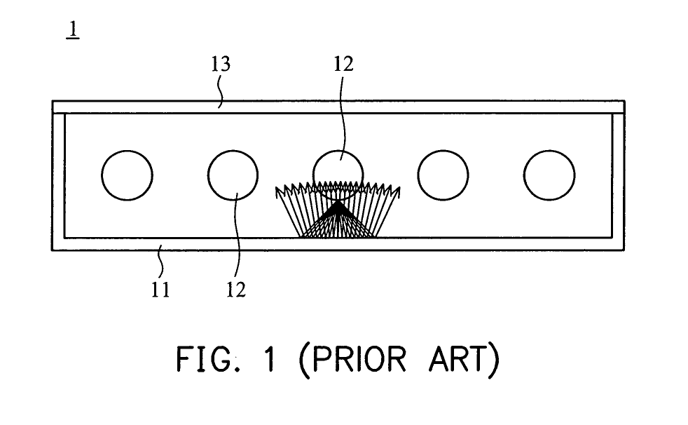

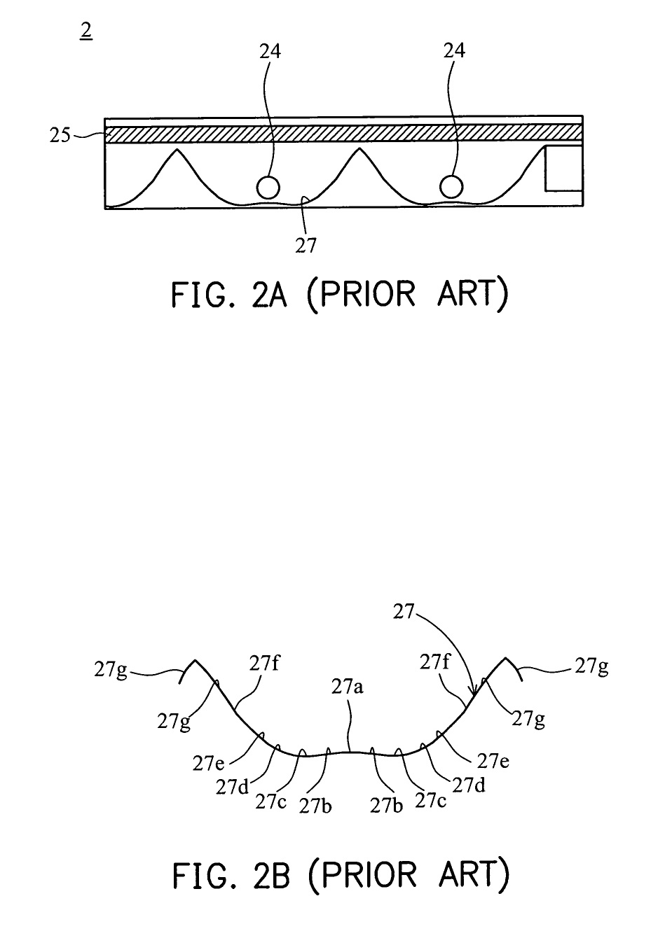

### DETAILED DESCRIPTION OF THE INVENTION

First embodiment

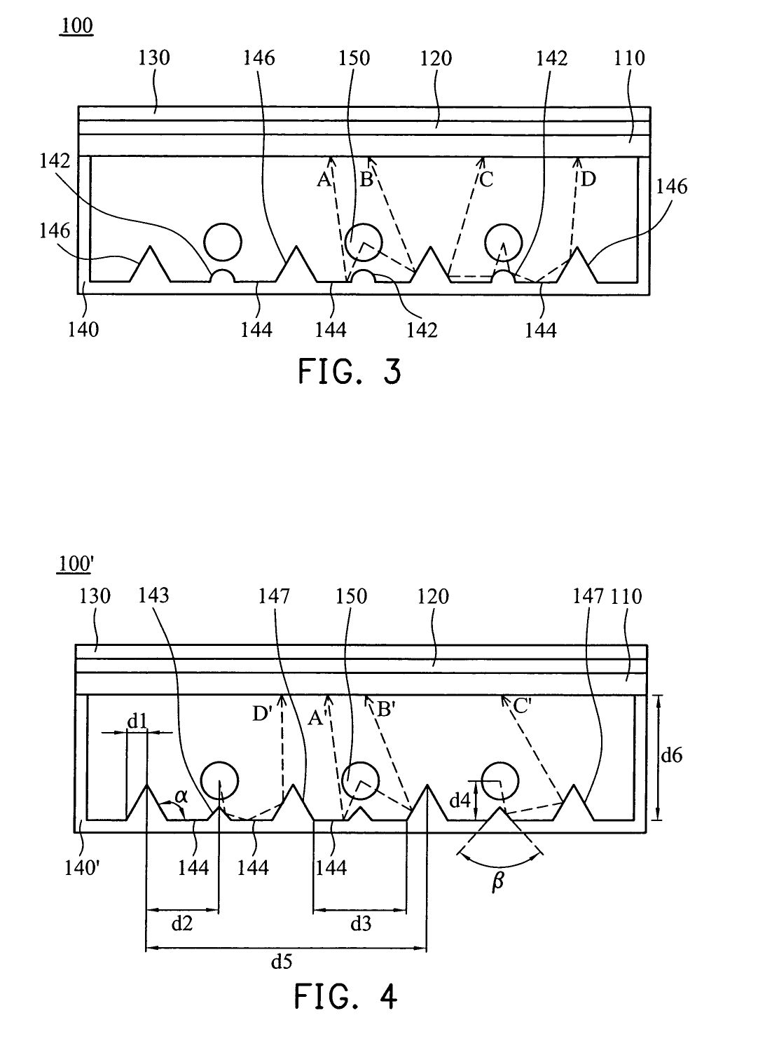

Referring to FIG. 3, the direct backlight module 100 comprises a diffuser 110, a prism 120, a diffusing plate 130, a reflecting plate 140 and a plurality of illumination tubes 150.

In this embodiment, the prism 120 is disposed on the diffuser 110 and the diffusing plate 130 is disposed on the prism 120. The arrangement and number of the prism 120 and the diffusing plate 130 can be changed as required.

The reflecting plate 140 is disposed under the diffuser 110 and has a plurality of curved surfaces 142, planar surfaces 144 and triangular protrusions 146. As shown in FIG. 3, the curved surfaces 142 are adjacent to the planar surfaces 144 and the planar surfaces 144 are adjacent to the triangular protrusions 146. Specifically, the height of the triangular protrusion 146 is greater than that of the curved surface 142.

The illumination tubes 150 are disposed between the diffuser 110 and the reflecting plate 140 and located above the curved surface 142. Thus, the light beams from the illumination tubes 150 enter the diffuser directly. In addition, the light beams from the illumination tubes 150 enter the diffuser via reflections among the curved surfaces 142, the planar surfaces 144 and the triangular protrusions 146.

As shown in FIG. 3, the light beams from the illumination tube 150 can enter the diffuser 110 via reflection of the planar surface 144, as shown by route A. The light beams from the illumination tube 150 can enter the diffuser 110 via reflection of the triangular protrusion 146, as shown by route B. The light beams from the illumination tube 150 can enter the diffuser 110 via reflections of the curved surface 142 and the triangular protrusion 146, as shown by route C. In addition, the light beams from the illumination tube 150 can enter the diffuser 110 via multiple reflections, as shown by route D.

Thus, the light beams from the illumination tube 150 can almost completely enter the diffuser 110 without ineffective light beams by adjusting the curvature of the curved surface 142, the inclined angle of the triangular protrusion 146 and the distance between the illumination tube 150 and curved surface 142.

Second embodiment

Referring to FIG. 4, the direct backlight module 100′ comprises a diffuser 110, a prism 120, a diffusing plate 130, a reflecting plate 140 and a plurality of illumination tubes 150.

The reflecting plate 140 is disposed under the diffuser 110 and has a plurality of first triangular protrusions 143, planar surfaces 144 and second triangular protrusions 147. As shown in FIG. 4, the first triangular protrusions 143 are adjacent to the planar surfaces 144 and the planar surfaces 144 are adjacent to the second triangular protrusions 147. Specifically, the height of the second triangular protrusion 147 is greater than that of the first triangular protrusions 143.

The light beams from the illumination tubes 150 enter the diffuser directly. In addition, the light beams from the illumination tubes 150 enter the diffuser via various routes.

In order to clearly express the preferred performance of the direct backlight module 100′, the symbols illustrated in FIG. 4 are described as follows:

α=137°

β=120°

d1=7.5 mm

d2=17.5 mm

d3=20 mm

d4=3.5 mm

d5=70 mm

d6=7.5 mm

As shown in FIG. 4, the light beams from the illumination tube 150 can enter the diffuser 110 via reflection of the planar surface 144, as shown by route A′. The light beams from the illumination tube 150 can enter the diffuser 110 via reflection of the second triangular protrusion 147, as shown by route B′. The light beams from the illumination tube 150 can enter the diffuser 110 via reflections of the first triangular protrusion 143 and the second triangular protrusion 147, as shown by route C′. In addition, the light beams from the illumination tube 150 can enter the diffuser 110 via multiple reflections, as shown by route D′.

While the invention has been described by way of example and in terms of the preferred embodiment, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A direct backlight module, comprising:
a diffuser;
a reflecting plate disposed under the diffuser and having a first reflecting portion, a second reflecting portion and a third reflecting portion, wherein the first reflecting portion is adjacent to the second reflecting portion and the second reflecting portion is adjacent to the third reflecting portion; and
an illumination tube disposed between the diffuser and the reflecting plate and located above the first reflecting portion, wherein the light beams from the illumination tube enter the diffuser directly and via reflections among the first reflecting portion, the second reflecting portion and the third reflecting portion.

2. The direct backlight module as claimed in claim 1, wherein the height of the third reflecting portion is greater than that of the first reflecting portion.

3. The direct backlight module as claimed in claim 1, wherein the first reflecting portion is a curved surface for reducing the ineffective light beams reflected back to the illumination tube.

4. The direct backlight module as claimed in claim 1, wherein the first reflecting portion is a triangular protrusion for reducing the ineffective light beams reflected back to the illumination tube.

5. The direct backlight module as claimed in claim 1, wherein the second reflecting portion is a planar surface.

6. The direct backlight module as claimed in claim 1, wherein the third reflecting portion is a triangular protrusion.

7. The direct backlight module as claimed in claim 1, further comprising a prism disposed on the diffuser.

8. The direct backlight module as claimed in claim 1, further comprising a diffusing plate disposed on the diffuser.

9. A direct backlight module, comprising:
a diffuser;
a reflecting plate disposed under the diffuser and having a curved surface, a planar surface and a triangular protrusion, wherein the curved surface is adjacent to the planar surface and the planar surface is adjacent to the triangular protrusion; and
an illumination tube disposed between the diffuser and the reflecting plate and located above the curved surface, wherein the light beams from the illumination tube enter the diffuser directly and via reflections among the curved surface, the planar surface and the triangular protrusion.

10. The direct backlight module as claimed in claim 9, wherein the height of the triangular protrusion is greater than that of the curved surface.

11. The direct backlight module as claimed in claim 9, further comprising a prism disposed on the diffuser.

12. The direct backlight module as claimed in claim 9, further comprising a diffusing plate disposed on the diffuser.

13. A direct backlight module, comprising:
a diffuser;
a reflecting plate disposed under the diffuser and having a first triangular protrusion, a planar surface and a second triangular protrusion, wherein the first triangular protrusion is adjacent to the planar surface and the planar surface is adjacent to the second triangular protrusion; and
an illumination tube disposed between the diffuser and the reflecting plate and located above the first triangular protrusion, wherein the light beams from the illumination tube enter the diffuser directly and via reflections among the first triangular protrusion, the planar surface and the second triangular protrusion.

14. The direct backlight module as claimed in claim 13, wherein the height of the second triangular protrusion is greater than that of the first triangular protrusion.

15. The direct backlight module as claimed in claim 13, further comprising a prism disposed on the diffuser.

16. The direct backlight module as claimed in claim 13, further comprising a diffusing plate disposed on the diffuser.
